(19) United States
(12) Patent Application Publication
(10) Pub. No.: US 2007/0100699 A1
(43) Pub. Date: May 3, 2007

(54) Interactive System and Methods to Obtain Media Product Ratings

(76) Inventor: Amir Ajizadeh, Ashburn, VA (US)

Correspondence Address: John M. White, PO Box 315, Waterford, VA, 20197, US

(21) Appl. No.: 11/619,596

(22) Filed: Jan. 3, 2007

Related U.S. Application Data
(63) Continuation-in-part of application No. 10/421,755, filed on Apr. 24, 2003, now abandoned.

(51) Int. Cl. G06Q 30/00

(52) U.S. Cl. 705/14

(57) ABSTRACT

An interactive polling data collection website designed so the general media product consuming public will have an opportunity to interactively submit their input on what media product they are or have just finished watching or listening to. People can log-on to the website and register as members. Once they are members, they can click on media product icons related to the media product they are or have just finished watching or listening to and provide their input about the media product according to polling queries. The collected polling data is electronically converted into an anonymous 3-part demographically related generic output data string and made available to purchasers where the data can be broken down and analyzed by off-site for their desired purpose.

This application is a continuation-in-part of application Ser. No. 10/421,755, filed Apr. 24, 2003, now abandoned.

### BACKGROUND OF THE INVENTION

1. Field of the Invention

The present invention relates to the field of television and radio ratings. More particularly, the present invention relates to reliable methods and systems for quickly and efficiently retrieving data input from system members that relates to a media product (i.e., a television program, a radio show, an advertising spot, etc.) review, converting that data into a personally anonymous but demographically specific output, and making that data available for off-site analysis.

2. Description of Related Art

Currently, there is only one major company that is regularly conducting statistical polling services for radio and television media products. A set-top box is placed with a “family” in their polling service system and the box passively monitors the viewing habits of the household as the information passes thru the set-top box. Some basic demographic information regarding the family is known, i.e., age and gender of members, etc., and, when combined with the viewing data, polling information is obtained that correlates the various pieces of information. This information is passed to those who might be interested and who have paid for and/or sponsored the research. This may include broadcast owners, show producers, various government institutions, advertisers, etc.

The currently known systems are not known to be and have not set forth any specifications or methods regarding interactive television and radio ratings. Many, many, proposals exist as far as interactivity are concerned but none are, as yet, mainstream or widely used. They are, for the most part, excessively complicated in both execution and data delivery.

The primary problem with the known major service is that the data service only collects data from a selected number of households and, from this limited data set, creates a statistical extrapolative analysis of the U.S. public average. The data pool is static in number and demography and, relative to the total population watching or listening, absurdly small and demographically limited. No statistical manipulation can make up for the dearth of sample depth and breadth. This is especially the case as programming becomes increasingly narrow in its focus and resulting appeal.

All participants in the television and radio business need and want more accurate and in-depth analysis of viewer/listener feedback.

### SUMMARY OF INVENTION

The present method and system, presently known as iTvRatings, is directed to an interactive published website designed so that any member of the general television viewing/listening public will have an opportunity to interactively submit their input on what program they are or have just finished watching/listening whenever they want. This media (television/radio) consumption polling website will serve as a Ratings data collection service for the public, television networks, television network affiliates, television stations, the media, advertising agencies, advertisers, sponsors of shows, production companies and other affiliates. Anyone who becomes a member of iTvRatings.com will have an opportunity to log into our website and record their input on what television show they have watched, or are watching, on a specific date and time and whether they liked or disliked the show, etc. By pressing the “send” button, their data input will be sent to a data warehouse where our software will break down the information from that member and place it into a standard output format in accord with polling queries. This information at iTvRatings will at least be broken-down internally as member name, address, email address, gender, age or age group, but may also include ethnicity, income, hobby, etc., along with whatever other demographic query is desired according to the requestor or input by the member. The collected polling data is made available in a standard anonymous output format that can be readily analyzed by customers. Thusly, offsite manipulation of the raw data is made possible, for any purpose or need of the data purchasing entity.

The specific iTvRatings polling can be adjusted to accommodate any type of query, to whatever extent the member polling sponsor desires and the member/participant is prepared to answer. A specific character or theme preference may be polled, length of program, timing during broadcast period, promotion, etc. iTvRatings is conceived as an all-purpose scientific polling method and system for the various members (users/distributors/providers) of the media industry for whatever polling query and demographic need for any member of the industry. The number of polling queries simply makes the standard output format somewhat longer but, owing to the output format, remains easy to manipulate offsite through whatever software/hardware the purchaser deems appropriate to use.

For example: A consumer member joins to obtain real time opinion of what is being watched and by whom and why. This could be a “Top Ten”, a “Most Watched”, etc. and can be broken down by age, zip-code, etc. In addition, they (the member) can input their own feedback about media products about which they have opinions. This input can be driven by a desire on the part of the consumer/viewer or can be driven by incentive (ie, coupon redemption, payment points for cable or satellite fees) depending on how frequently and extensively they answer polling questions.

For example: An advertising member joins to assess the acceptance of their advertising product and its placement according to predetermined demographic needs of the products. Is a beer commercial being viewed along with a program watched mostly by those under or over the age of 21? An advertising member can create/sponsor/incentivise polling queries to suit their purpose. I.e., to determine program suitability, consumer acceptance, market penetration, etc., and generate product interest through discounts, joint promotions, points toward prizes, etc.

For example: A programming/content provider can join to also sponsor/create/incentivise polling to suit an evaluation of their product and salability to advertisers. A business/political/public interest member can join to perform polling that is of interest to them for sociological/cultural/political reasons. These can be done on a volunteer basis or through incentivised polling (coupon redemption (free coffee, French fries, store and product discounts), cash equivalents (points toward pay-per-view, reduction in cable/satellite fees).

These various multi-level members can engage or not according to the willingness of the members and the incentive schedule being offered. Any media product can indicate its association with iTvRatings by simply showing the logo on screen or playing the jingle on a radio spot. The public seeing the logo or hearing the jingle knows the show or spot has an icon on the iTvRatings site that can simply be clicked and polling info input. If a show or spot has no iTvRatings logo shown, the media product can still be rated by Channel icon (ie, MTV, CBS, DISC., etc.) that will also be listed on the site, the ratings and input process will just take a little longer. For media products that do show a logo, however, an iTvRatings instant rating stars symbol may also appear alongside the logo so that people watching can know that a show it highly rated. For example, a 4 out of 5 star rating would be rated more highly than a 2 out of 5 star rating.

The iTvRatings system relies on known hardware and software and widely available internet connectivity to deliver the method and system. As such, several hardware systems and their connectivity will be incorporated herein by reference thereto.

### BRIEF DESCRIPTION OF THE DRAWINGS

FIG. 1 shows a flow chart indicating the major elements of the system necessary to accomplish the present invention.

FIG. 2 shows the data flow during polling.

FIG. 3 shows a standard anonymous polling output data string.

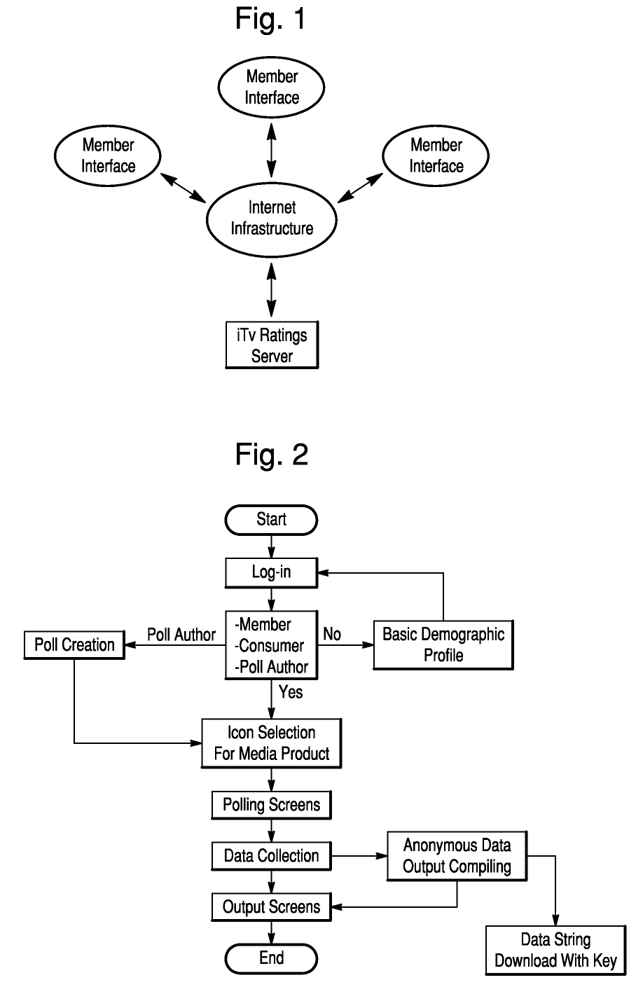

### DETAILED DESCRIPTION

We have created a website that is freely open for membership to any person or entity who can access the site via the web or telephone. For example, members of iTvRatings.com, individuals or families, can go to the website and input what Television show or station they are watching at a specific time of the day. Individuals or families become members of iTvRatings.com by going to the website and filling out a basic form that will establish them as our member. This form will ask basic demographic questions such as:
Name: (Used for identification purposes)
Address: (Used for verification of U.S. residency and for awards forwarding, zip code may suffice for non-redeemable point members.)
Gender: (Used for Gender identification and associated demographics)
Date of Birth: (Used for age grouping demographic purposes)
Ethnicity: (Used to average out the population as whole or within a market)
Email Address: (Used for login and individuality purposes and awards)

The foregoing basic demography will be enhanced by whatever further information polling member/users may seek (and participants are willing to provide) owing to their specific need for media consumption information. Hobbies, spending habits or intent, level of education, income brackets, Medicare status, veteran status, etc., may all be requested and, depending on the incentives offered (i.e., free merchandise, redeemable coupons, etc.) it may be provided on a discretionary (and anonymous) basis.

When these individuals input at least their basic information, our database will issue them a membership ID (this could be their email address) and a password for future log-in into our website. Member's personal information is confidential and it is used for our internal verification and award making purposes only. Following entry of the basic information, the individual member, or a family as a whole member, will become part of the iTvRatings.com website. Each time this member logs on, their basic anonymous membership demographic is known as a data string. This data string is a simple numeric characterization of their basic demographics. The 1^{st} number is their gender (for example, a 1 (male) or 2 (female)), the 2^{nd} and 3^{rd} number is their birth year (for example 87 (as in 1987), the fourth number is the ethnicity (for example, 1 is White, 2 is Asian, 3 is African American, 4 is Native American, etc.), the next 5 numbers comprise their zip code. Hence, a member number: 190310019, reflects 1 (male) 90 (born in 1990) 3 (Asian) 10019 (mid-town Manhattan), is an Asian male living in NY and born in 1990. The 10^{th} number (or whatever number follows the basic demographic info) is always a zero, so the system can always recognize a valid data string. The numbers following the basic member demographic data string (11+) reflect polling answers, each being a 0-9 that relates to a yes (1), no (0), or rating (2-9) or (a=2, b=3, c=4, etc) in response to the relevant query. Accordingly, a standard format data string output following a 10 question poll using yes or no responses might be: 19031001901111100000. Such a data string translates to a 16 year old Asian male living in NY answering 5 polling queries as a yes and 5 as a no. The data provided, therefore, outside of iTvRatings, importantly, does not include name and email address but does include basic demographics. A family or household membership would merely reflect an accumulation of individual data strings previously input and associated with that specific family membership. Each time polling data is input, the standard output would be that series of data strings reflecting the individual family members with the polling answer data following in the ordinary manner associated with an individual data string.

The particular order of the numeric identifiers in the supplied data string does not matter, per se. That is, the first number may be ethnicity, followed by age, etc. Regardless of the sequence of data in the data string, however, it must be in accord with an agreed key so that the data string is in a format that is easily taken into whatever data format that is useful to consumers/users of the data. The key would provide information as to the order of numbers and what they meant as to the media product ID, demographic information, and the polling queries.

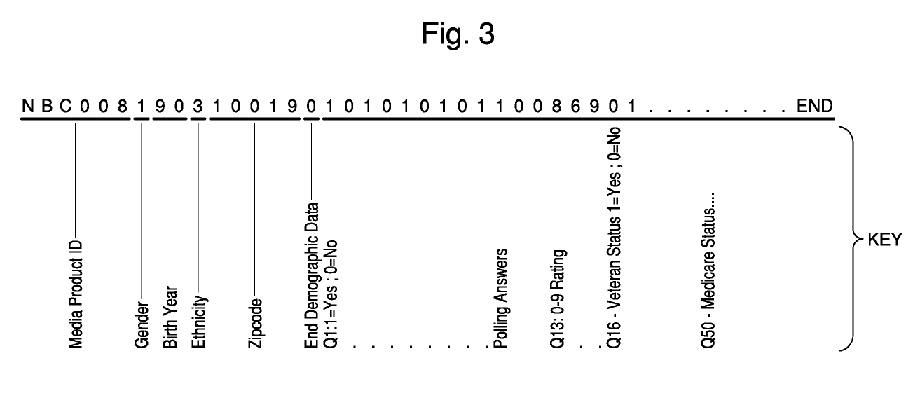

The media product ID is a numeric or alpha numeric that precedes any data string output so that the polling answers are associated with a specific media product. For example: NBC008 may identify an NBC product shown in the 8^{th} hour of the day East Coast time. Or, alternatively, AB0005 may be an advertiser (Anheuser Busch) and their 0005 media product. The alpha portion may be a numeric as well, as along as a suitable identifier key is provided. FIG. 3 herewith illustrates a sample 3-part data output string and associated key. The initial portion of the data string comprises a media product identifier, the following portion is the anonymous demographic characteristic associated with the polling data input person, and the remaining portion of the data string corresponds with the polling answers and, potentially, additional demographics.

The data strings can be expressed for third party consumption and analysis in the format of standard spreadsheet presentations such as MS Excel and/or MS Access. The first column can reflect the first alpha numeric character, the second column the next, etc., until all the data string information is presented. By placing the data string into such a generic format and associating the data string with a “key”, the data is easily transmitted using known and readily available off-the-shelf hardware/software set-ups and likewise, can just as easily also using known software/hardware set-ups, be analyzed. There is no need for expensive in-house analysis and report prep and presentation. Any third party can easily accept and analyze the data themselves off-site in whatever time frame and according to whatever system is most useful to their purpose. The iTvRatings site serves as data collector and forwarder for data users. The output data strings can be available in individual form or in consolidated form. That is, totals of the respective demographic columns can be made available, for example, totals for certain age categories, ethnicities, etc. This consolidated anonymous format would be, owing to the lesser size, more easily forwarded to customers for their own offsite analysis. But, if customers want the single raw data strings, those can be made available as well.

An example of a polling oriented website with membership features that would enable the current method is disclosed in US Patent Application Publication US 2003/0200137 A1, the contents of which are incorporated herein by reference thereto. The '137 document describes the multi-level membership aspects and initial data collection at paragraphs 0042-0053 thereof. The poll authoring is described at paragraphs 0099-0114 of the '137 document.

An iTvRatings.com family member will have access to our website and be able to log in with us at any given time to give us their input. They can tell us what media show they are watching/listening to or have just finished watching by clicking on screen icons associated with a media provider identifier (e.g, ABC, ESPN, CBS, CNBC, FOX, DISC, or FORD, GM, INTEL, etc.), responding to the polling queries, obtaining any incentives available, and pressing the send button. This converted anonymous polling data will be provided to (given, traded, or sold) other commercial/political/service members of iTvRatings. Such other members might include television networks, television network affiliates, television stations, the media, advertising agencies, advertisers, sponsors of shows, production companies and other paying affiliates for there own statistical breakdown according to whatever criteria is useful to them.

Simple polling inputs of basic consumer oriented polling queries might include:

Polling Ranks: a tool bar in the voting page displayed to help rank the enjoyment level of the show by the member. The poll ranking is displayed from number 1 to number 10, 10 being most favorable. This poll ranking would demonstrate the level at which the viewer liked or disliked the program. The rank would simply report in the data string as a single digit, in accord with the agreed sequence of the rank information, i.e., 11^{th} digit is the rank and is listed as a 1 to a 10 (shown as a 0).

Shared Polling: a tool bar in the voting page will display a shared polling bar. The shared polling bar will give the member an opportunity to register their input on how many people viewed the show with the member. The options are from one additional person to over 5 viewers. In this way, a family member can enter polling answers for all members of the viewing family using a single data input.

Pages that members would also have access to might optionally include:

Results page: the results link will have the top 10 or more shows for the prior day or the day of viewing. This page is structured for all members to view so as to know how many people watched the shows that are in the top 10 or more by viewer ranking. The number 1 show would be the show that had been viewed the most by members regardless of whether the viewers liked the show or not. A breakdown of the most viewed TV shows would also be displayed for the week or month. The result shows the total amount of votes in an analytical format. Breakdown may further consist of anonymous member demographic information, i.e., age, ethnicity, zip code, gender, etc.

These basic results, once past a certain predetermined threshold for a given show, would form the basis for generation an iTvRatings star rating for that media product. For a show with a small audience pull, ie, a hobby show, once it had been rated by as few as 100 viewers, a star rating would be created and placed onto the viewing screen. For a more widely viewed drama or news show, the predetermined number might be 1000 viewer ratings before an iTvRatings star rating would appear. Once a rating had been established, the media product provider could electively show the iTvRatings star-rating on-screen adjacent to the iTvRatings logo. This could be shown briefly following commercial breaks and inform viewers as to the rated merit of the show.

A rapid return rating system is described in US Patent Application Publication 2002/0053077, the contents of which are incorporated by reference thereto. The rating in the '077 system is provided in a viewing guide. In the current method, the rating would be preferably provided as an on screen icon associated with a iTvRating Star rating indicator.

Additional features might optionally include:

Message board: A member based message board will allow members to share their thoughts on a specific TV network, TV show, actors or any inoffensive thoughts that members want to share within this page for everyone to view. The message board would also serve as a communication base for all members. Members are able to control their input by adding to or deleting their input.

Personal Critic Pages: Members are given the opportunity to create and customize their preferences on a personal page. They will be able to create a page for themselves on the site where other members can view other members' pages and would be able to communicate with each other. Communication options would consist of utilization of known instant messaging, email and chat technologies. The personal pages would also allow TV networks to send reminder messages to members regarding an upcoming show. Members are also able to place TV shows or clips of TV shows on their personal pages for entertainment purposes. Members would have the ability to download and upload photos and video. Suggested Personal Page features would include: Photo and video upload and download; Share personal page with others or keep private; Use chat and email technologies to communicate with others; Post blogs and messages on their page; Create and modify a profile; Add other members to their friends list; Use telephone technology to send messages from their page to their friends. Personal pages will have certain items as default, such as: members name and the time-zone that they are assigned to when signing up for membership.

The interactive components of the website as noted above, i.e., chat functions, instant messaging, etc., can be enabled through a system such as that disclosed in US Patent Application Publication US 2002/133562 A1, the contents of which are incorporated herein by reference. These inactive aspects are principally disclosed in FIG. 2, paragraph 0031 of the '562 application.

Telephone server technology: this technology would allow TV Show production companies, TV sponsors, TV networks and members to send other members celebrity voice-overs for the purpose of promoting their shows or certain episodes. Members would be able to use this server based technology to customize certain messages for a specific member and send the message as text or voice-over to that member. Within this server, members or iTvRating.com clients would be able to customize a message using recipient name, occupation, hobby and other personal notes to customize the message prior to sending the message. The recipient would receive this message using the celebrity's voice for the purpose of promoting a TV show or episode. A personal invitation from the Star of the show to remember to watch and enjoy the show!

A hardware/software system capable of supporting the telephone polling requirements of this method are disclosed in US Patent Application Publication US 2003/0100321 A1, the contents of which are incorporated herein by reference. The current method relies on the opinion surveying aspects of the '321 disclosure as shown principally in FIG. 3 thereof and as described in paragraph 0015.

TV show promotions: TV shows are able to promote their programs or network by applying links to their shows or networks on iTvRatings.com. These icons would link members to TV show, networks or sponsors.

Including a hyperlink or other icon on screen on a TV show is known and is disclosed in US Patent Application Publication US 2002/0087969 A1 the contents of which is incorporated herein by reference thereto. The inclusion of links and/or icons is described in the '969 document principally at page 3, paragraph 0041, in conjunction with FIG. 2 thereof.

Where polling query answering is performed on an incentive basis, i.e., in exchange for rewards, an account can be created whereby a member can accumulate points redeemable towards goods and discounts such as the poll sponsor may select. For example, a sporting goods advertiser on a soccer program could offer coupons towards discounts on specific merchandise. For example, a cooking show could offer points redeemable for kitchen equipment or cooking lessons, etc. A system for creating and maintaining such accounts is described in U.S. Pat. No. 6,604,239, the contents of which are incorporated herein by reference thereto. The description of the prize associated accumulation of redeemable points is described in the '239 document at column 7, beginning at line 45.

Chat: using chat technology, members and clients are able to chat using instant text messaging. Members are able to chat with other members. Chat and discussion forum technology sufficient for enablement of the present method are disclosed in the '239 document, beginning at column 7, line 40.

Cable Server Ratings Verification: Ratings verifications are made possible through cable box receivers or other set-top box where a signal is sent through the box to the media consuming device. A monitoring signal is sent back to the cable/satellite/broadcast company server through the internet. This monitoring enables the retrieval of information on which house hold is watching which program. If the channel does not change within 3 hours, we know the likely hood of someone watching the program is low. The signal will give us time and date of the viewing program. This information can be used as validation of a viewer/member and their later inputted viewing habits.

We will also structure a specific web page that the member will be automatically directed to in accord with members' geographical television marketing area. Every time a member logs into our site he/she will be directed to the appropriate geographic start page for polling. The new member will from that point on be able to log in at anytime and give us information regarding what television show they have watched. They do this by using their log in name and password. At this point they will see a page that will clearly identify that specific user and the user will be given choices on what they have watched. The member's choices on the screen will, for example, be as follows: the date, time of viewing or log in, the name of the television network, station or cable. The icons in front of choices can be clicked on using a computer mouse. The choices will also include a button for “none” if they did not watch television at that moment. Once the choice has been selected they will be required to press the send button and the input will be sent to our data base where is will be broken down for our internal use. An icon button can also be pushed on a member's behalf to let us know whether they liked or disliked the show.

The iTvRatings internal data base will break down the information that the member has just sent to us via our website. Our data base will break down the anonymous data into different categories for our own internal use and website display. The break down will consist of: gender, age, geographical territory (market) and ethnicity. A limited amount of this information will be released to the general public and detailed information, reflecting further polling queries, will be released to the other clients to the extent requested by member created polling queries.

Another method of television and radio ratings system using this system can consist of issuing a specific toll free or local calling numbers whereas a viewer or listener can call the phone number that is specifically designated for a specific television show, network or station. By calling a specific phone number, by our designation, viewers or listeners will be telling us what television show they are watching or what radio station or show they were or are listening to. This version of the current method could be used for the general public who don't have access to a computer or access to a computer at that specific moment. A person can answer polling queries using their telephone keypad.

Streaming Video: Members would have an opportunity to stream live shows through our website. Full authorization by networks and sponsors would allow us to download or connect into a server whereas, members can connect into and view earlier taped or live shows provided by networks. During or after the shows downloaded by a member, the member would rate the show through the website. Such streaming services would be enabled through off-the-shelf systems such as those used by uTube, AOL Video, Akamai, Real Networks, etc.

The disclosed method and systems herein are limited only by the following claims.

What I claim as my invention is:

1. A membership based internet method for collecting and distributing demographically related media product ratings data, comprising the steps of:
a member logging onto a website where said member has previously entered personal data including name, zip code, gender, date of birth, ethnicity, and email, and, in exchange therefore, has obtained membership status and password information to log onto said website as a member;
selecting an icon from a menu screen, said icon representing a media product;
indicating a specific product rating in response to polling queries specific to said media product thereby creating a polling input;
sending said polling input to a main computer;
converting said polling input according to a predetermined set of criteria into an anonymous standard output numeric data string, said data string including a first part reflecting a specific media product, a second part reflecting demographic information related to said member, and a third part reflecting said polling input; and,
enabling selected aspects of said data string to be available to members according to their membership status.

2. A method as in claim 1, further comprising:
placing said data string into a standard spreadsheet format wherein data elements comprise corresponding columns of said spreadsheet format.

3. A method as in claim 2, wherein:
said media product comprises a television advertisement.

4. A method as in claim 2, wherein:
said data string information in said standard spreadsheet is consolidated into summary form reflecting accumulated totals related to member demographic information.

5. A membership based method for conducting television and radio show ratings polling, comprising the steps of:
a first member logging onto a website where the first member has membership status as a media poll creator;
selecting a media product for which a poll is to be created and, thereafter,
assembling a poll for a media product from a combination of predetermined and/or custom created polling queries;
optionally attaching incentives to the assembled polling queries to be given at selected thresholds of polling answers;
associating a poll so created with a media product; thereafter,
a second member logging onto a website where said second member has previously entered personal data including name, zip code, gender, date of birth, ethnicity, and email, and in exchange therefore has obtained membership status and password information as a media consumer;
said second member selecting from a menu, including icons representing media product information;
selecting a specific media product by date and time or none, if no show had been watched;
inputting information as to the member's opinions regarding the show along with any other requested information in response to said created poll;
sending the inputted information to a main computer;
converting the inputted information according to a predetermined set of criteria into a standard format anonymous data output string, and,
enabling selected aspects of said data output string to be available to members according to their membership status.

6. A method as in claim 5, further comprising:
exchanging incentives associated with said polling answers for sponsored products appearing on said website.

7. A method as in claim 5, further comprising:
entering a chat function on said website to contact other members on said website.

8. A method as in claim 7, further comprising:
creating a personal critic page wherein a member can post personal commentary with respect to a media product for other website members to view.

9. A method as in claim 7, further comprising:
accessing a media product review results page for viewing of accumulated polling data from a poll conducted through said website.

10. A method as in claim 5, further comprising:
placing said data string into a standard spreadsheet format wherein data elements comprise corresponding columns of said spreadsheet format.

11. A method as in claim 10, wherein:
said data string information in said standard spreadsheet is consolidated into summary form reflecting accumulated totals related to member demographic information.

12. A data string output element from a member based media polling method, comprising:
a first part indicating a specific media product;
a second part corresponding to anonymous demographic information specific to an individual member of said polling service; and,
a third part corresponding to polling answers associated with polling queries specific to said specific media product.

13. A data string output element as in claim 12, wherein:
said first part is expressed as an alpha-numeric.

14. A data string output element as in claim 13, wherein:
Said data string is expressed in a standard spreadsheet format.

15. A data string output element as in claim 14, wherein:
multiple data strings are summarized in demographically related totals in said spreadsheet format.
